(19) United States
(12) Patent Application Publication
(10) Pub. No.: US 2010/0079630 A1
(43) Pub. Date: Apr. 1, 2010

(54) IMAGE PROCESSING APPARATUS, IMAGING DEVICE, IMAGE PROCESSING METHOD, AND COMPUTER PROGRAM PRODUCT

(75) Inventors: Nao Mishima, Tokyo (JP); Kenzo Isogawa, Kanagawa (JP); Masahiro Baba, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/560,601

(22) Filed: Sep. 16, 2009

(30) Foreign Application Priority Data
Sep. 29, 2008 (JP) 2008-251658

(51) Int. Cl. G06K 9/40; H04N 9/64

(52) U.S. Cl. 348/248; 382/255; 348/E09.037

(57) ABSTRACT

An image processing apparatus includes a blur reproducing unit that generates blur-reproduced image data by reproducing a predetermined blur of a lens, with respect to blur-corrected image data of which an initial data is input image data inputted from an image sensor; a blur correcting unit that corrects the blur-corrected image data so that an error between the blur-reproduced image data and the input image data becomes smaller; and a curved-surface fitting unit that obtains curve surface parameters of each functions approximating distribution of pixel values of each of color components of the blur-corrected image data so that curved-surface shapes of the functions become the same among the color components, and updates the pixel values of the blur-corrected image data by using the curve surface parameters.

### CROSS-REFERENCE TO RELATED APPLICATIONS

This application is based upon and claims the benefit of priority from the prior Japanese Patent Application No. 2008-251658, filed on Sep. 29, 2008; the entire contents of which are incorporated herein by reference.

### BACKGROUND OF THE INVENTION

1. Field of the Invention

The present invention relates to an image processing apparatus, an imaging device, an image processing method, and a computer program product.

2. Description of the Related Art

Conventionally, there are techniques of correcting various aberrations included in an image output from an image sensor. When an external light beam is collected on an image sensor by a lens, the image sensor photoelectrically converts the light beam into a charge and accumulates charges. Even when the image sensor corresponds to higher resolution, an image blur occurs when condensation of the lens does not correspond to the resolution.

For example, “Iterative methods for image deblurring” (J. Biemond, R. L. Lagendijk, R. M. Mersereau, Proceedings of the IEEE, Volume 78, Issue 5, Pages: 856-883, May 1990), discloses deblurring of a blurred image by the Landweber method. “Iterative methods for image deblurring” further discloses suppressing of noise by regularization. Although the use of the Landweber method makes it possible to compensate for a reduction of a relative performance of the lens, the Landweber method is not suitable to control noise. Therefore, by normally suppressing noise, a blur can be corrected satisfactorily.

For example, JP-A 2005-354610 (KOKAI) discloses an invention of an image processing apparatus and the like as follows. The image processing apparatus generates an estimated image by simulating an input color image captured by a single-chip image sensor, simulates an optical blur of the estimated image, and compares the simulated image with the captured image, thereby calculating a blur correction amount. The apparatus further calculates a penalty of an unnatural response by using correlation of color, and corrects the blur based on the blur amount and the penalty. The invention of the image processing apparatus or the like disclosed in JP-A 2005-354610 (KOKAI) is a method of proper regularization based on the presence of correlation of color.

Regularization in image processing has a restriction such that a variation of near pixel values is smooth. Image data by a single-chip image sensor has only a single color of each pixel position. Therefore, in a case of determining the presence of correlation between adjacent pixels, a pixel interpolation has to be made. Consequently, the image data by the single-chip image sensor has a problem that the resolution for controlling regularization depends on precision of the interpolation, and its original resolution is not effectively used. However, the invention of the image processing apparatus or the like disclosed in JP-A 2005-354610 (KOKAI) does not take this matter into consideration.

### SUMMARY OF THE INVENTION

According to one aspect of the present invention, an image processing apparatus includes a blur reproducing unit that generates blur-reproduced image data by reproducing a predetermined blur of a lens, with respect to blur-corrected image data of which an initial data is input image data inputted from an image sensor; a blur correcting unit that corrects the blur-corrected image data so that an error between the blur-reproduced image data and the input image data becomes smaller; and a curved-surface fitting unit that obtains curve surface parameters of each functions approximating distribution of pixel values of each of color components of the blur-corrected image data so that curved-surface shapes of the functions become the same among the color components, and updates the pixel values of the blur-corrected image data by using the curve surface parameters.

According to another aspect of the present invention, an imaging device includes a lens that collects an external beam; an image sensor that accepts the the external beam via the lens and outputs image data as input image data; a blur reproducing unit that generates blur-reproduced image data by reproducing a predetermined blur of the lens, with respect to blur-corrected image data of which an initial data is the input image data; a blur correcting unit that corrects the blur-corrected image data so that an error between the blur-reproduced image data and the input image data becomes smaller; and a curved-surface fitting unit that obtains curve surface parameters of each functions approximating distribution of pixel values of each of color components of the blur-corrected image data so that curved-surface shapes of the functions become the same among the color components, and updates the pixel values of the blur-corrected image data by using the curve surface parameters.

According to another aspect of the present invention, an image processing method includes generating blur-reproduced image data by reproducing a predetermined blur of a lens, with respect to blur-corrected image data of which an initial data is input image data inputted from an image sensor; correcting the blur-corrected image data so that an error between the blur-reproduced image data and the input image data becomes smaller; and obtaining curve surface parameters of each functions approximating distribution of pixel values of each of color components of the blur-corrected image data so that curved-surface shapes of the functions become the same among the color components; and updating the pixel values of the blur-corrected image data by using the curve surface parameters.

A computer program product according to still another aspect of the present invention causes a computer to perform the method according to the present invention.

### BRIEF DESCRIPTION OF THE DRAWINGS

FIG. 1 is a block diagram illustrating a functional configuration of an imaging device according to a first embodiment of the present invention;

FIG. 2 is a schematic diagram illustrating an outline of an image processing method according to the first embodiment;

FIG. 3 is a diagram illustrating image data obtained from an image sensor;

FIG. 4 is a diagram illustrating another image data obtained from the image sensor;

FIG. 5 is a flowchart for explaining details of a differentiating step;

FIGS. 6A to 6D are diagrams illustrating operation examples for obtaining first derivatives in the Bayer arrangement;

FIGS. 7A and 7B are diagrams illustrating examples of an anisotropic Gaussian function;

FIGS. 8A to 8G are diagrams illustrating image-structure kernel parameters by the anisotropic Gaussian function;

FIG. 9 is a flowchart for explaining details of a blur reproducing step;

FIG. 10 is a schematic diagram for explaining a PSF for each color component;

FIG. 11 is a flowchart for explaining details of a blur correcting step;

FIG. 12 is a schematic diagram for explaining the PSF for each color component;

FIG. 13 is a schematic diagram for explaining an image characteristic classification by Harris et al.;

FIGS. 14A and 14B are diagrams illustrating curved surfaces of RGB before and after curved-surface shapes are interconnected by the RGB, respectively;

FIGS. 15A and 15B are diagrams illustrating other curved surfaces of RGB before and after curved-surface shapes are interconnected by the RGB, respectively;

FIG. 16 is a flowchart of details of a curved-surface fitting step;

FIG. 17 is a block diagram illustrating a functional configuration of an imaging device according to a second embodiment of the present invention;

FIG. 18 is a schematic diagram illustrating an image processing method according to the second embodiment;

FIG. 19 is a flowchart for explaining an outline of a process according to the second embodiment;

FIG. 20 is a flowchart for explaining details of a filtering step;

FIG. 21 is a schematic diagram for explaining a LSF for each color component; and

FIG. 22 is a diagram illustrating an example of a hardware configuration of an image processing apparatus.

### DETAILED DESCRIPTION OF THE INVENTION

Exemplary embodiments of the present invention will be explained below in detail with reference to the accompanying drawings. The configuration according to the embodiments of the present invention is a configuration of an imaging device used as a digital camera or the like. According to the embodiments, an external light beam is collected by a lens onto an image sensor. The image sensor photoelectrically coverts the light beam into a charge, and accumulates the charge. The accumulated charge is input to the image processing apparatus according to the embodiments, and the image processing apparatus corrects an optical blur. In the following embodiments, a color image by a single-chip image sensor is explained by using RGB (red-green-blue). However, in the embodiments, it is not limited to RGB and complementary colors can be also used.

According to an image sensor manufactured by a semiconductor process, density of transistors formed on the image sensor increases along the progress of microfabrication of a semiconductor process rule. Consequently, high resolution of a generated image is achieved. However, the improvement of performance of the lens collecting a light beam onto the image sensor is less than that of the image sensor, due to complexity of an optical design and demands of downsizing of a lens system. Therefore, even when high resolution of the image sensor is achieved, an image in high resolution cannot be obtained when performance of the lens collecting light is not so high, and a generated image has a blur.

In the following embodiments, there is explained a method of deblurring an image without degrading resolution, by effectively using all information on a single-chip image sensor, by interconnecting curved-surface shapes of RGB by using a local polynomial regression (the kernel regression).

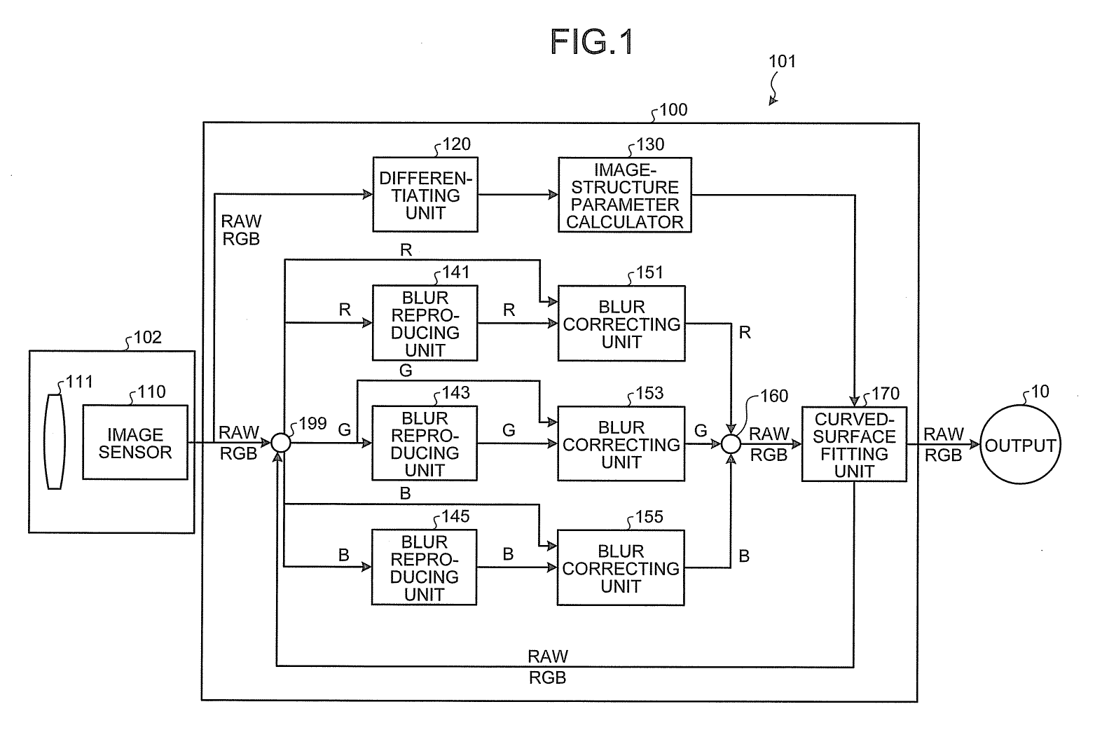

An imaging device 101 shown in FIG. 1 includes an imaging unit 102 and an image processing apparatus 100. The imaging unit 101 includes a lens 111 and an image sensor 110. The lens 111 collects external light beam onto the image sensor 110. The image sensor 110 photoelectrically converts light collected by a lens 111 into a charge, and outputs image data of RGB to the image processing apparatus 100. The output image data is RAW data.

The image processing apparatus 100 includes a differentiating unit 120, an image-structure parameter calculator 130, a blur reproducing unit 141, a blur reproducing unit 143, a blur reproducing unit 145, a blur correcting unit 151, a blur correcting unit 153, a blur correcting unit 155, a multiplexer 160, a curved-surface fitting unit 170, and a demultiplexer 199.

The differentiating unit 120 calculates first derivatives in an x-direction and a y-direction, from the RAW data of an image. The image-structure parameter calculator 130 calculates a parameter of an image structure from the first derivatives. The parameter of the image structure is expressed by an anisotropic Gaussian function, for example.

The blur reproducing unit 141 simulates a blur of an R component out of the RAW data by the image sensor. The blur correcting unit 151 outputs a blur-corrected image that minimizes an error of the least squares of a blur reproduction image of the R component generated by the blur reproducing unit 141 and a blur-corrected image that is an image after a blur is corrected.

The blur reproducing unit 143 and the blur correcting unit 153 process a blur reproduction and a blur correction of a G component. The blur reproducing unit 145 and the blur correcting unit 155 process a blur reproduction and a blur correction of a B component. The multiplexer 160 encodes data of a correction image of each blur-corrected color component, and prepares the encoded result as RAW data.

The curved-surface fitting unit 170 uniforms, between RGB, curved-surface shapes connecting between pixel values for each color component, thereby properly performing regularization. To “uniform, between RGB, curved-surface shapes connecting between pixel values for each color component” is referred to as “interconnecting curved-surface shapes by RGB”.

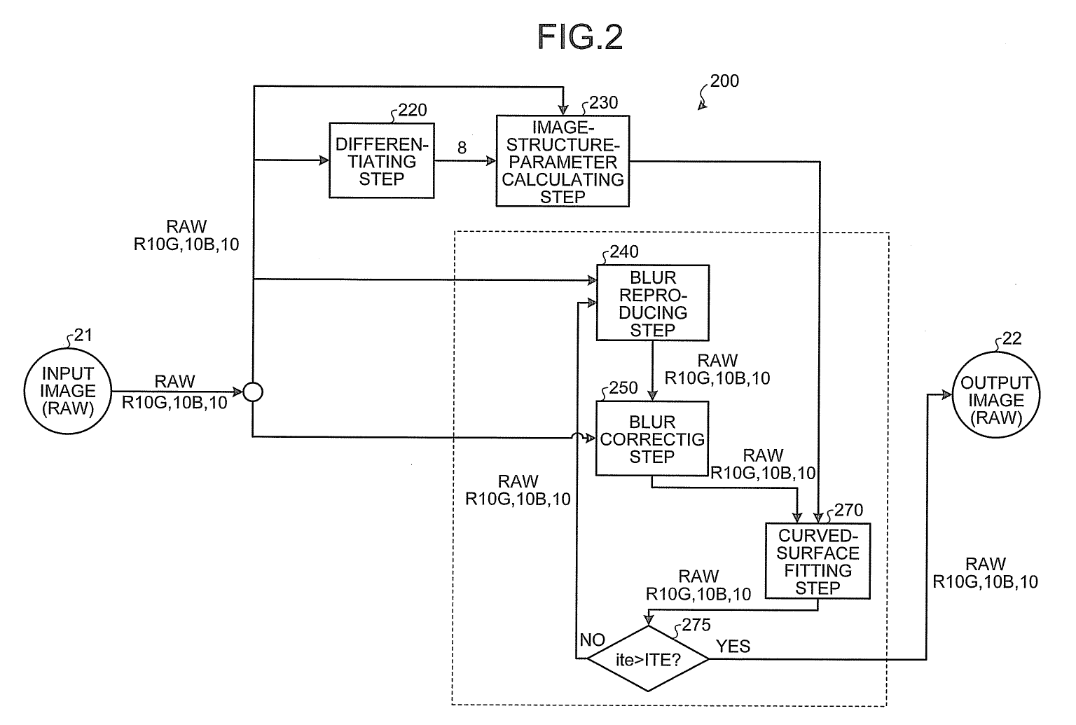

FIG. 2 is a schematic diagram for explaining an outline of an image processing method by the image processing apparatus 100 according to the first embodiment. In the first embodiment, a deblurring algorithm based on the Landweber method is used, and curved-surface fitting is performed by the kernel regression for regularization.

The deblurring algorithm of the Landweber method includes a blur reproducing step 240 and a blur correcting step 250. The Landweber method independently performs each step for each color component of RGB.

The curved-surface fitting by the kernel regression includes a differentiating step 220, an image-structure-parameter calculating step 230, a curved-surface fitting step 270, and a determination step 275. The curved-surface fitting is performed by using color components of RGB.

The differentiating step 220 and the image-structure-parameter calculating step 230 are performed only once for input RAW data. The blur reproducing step 240, the blur correcting step 250, and the curved-surface fitting step 270 are repeatedly performed to an optional number of times of iteration ITE. A number of times of iteration is determined at the determination step 275. A blur-corrected image is output last.

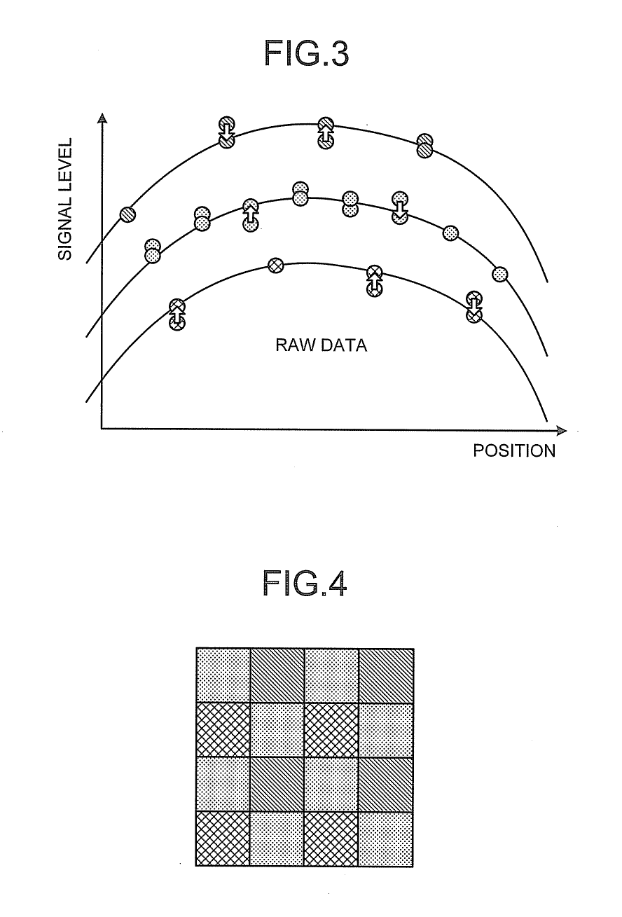

FIG. 3 depicts pixel values of three color components at continuous 16 pixel positions. The pixel values shown in FIG. 3 are image data obtained by the image sensor having the Bayer arrangement, for example. In the Bayer arrangement shown in FIG. 4, hatchings of dots are pixel positions for obtaining pixel values of G, hatchings of diagonal lines are pixel positions for obtaining pixel values of R, and hatchings of crossed diagonal lines are pixel positions for obtaining pixel values of B.

In FIG. 3, only data of one color is present at each pixel position. By interconnecting, by RGB, curved-surface shapes connecting between pixel values for each color component, regularization can be performed by using all data on the image sensor.

In the first embodiment, image data of which color filter arrangement is obtained from the single-pixel image sensor of the Bayer arrangement is processed. However, the embodiments of the present invention are not limited to the Bayer arrangement, and other color filter arrangements can be used.

Details of the image processing method according to the first embodiment will be explained below for each step shown in FIG. 2. Image data output from the image sensor is called RAW data here. The RAW data of a pixel position i=(i, j)^{T} is expressed as yᵢ. A color filter arrangement is expressed as cᵢ∈{R, G, B}. A corrected image to be obtained is expressed as xᵢ. How an image is blurred by optical blur can be described by a point spread function (hereinafter, “PSF”). A PSF of a color cᵢ at a local position s=(s, t)^{T} centered around a pixel position i is expressed as h(s, i, cᵢ). This PSF is known. The PSF can be obtained in advance by simulation or measurement based on a design value of the lens.

FIG. 5 is a flowchart for explaining details of the differentiating step 220 performed by the differentiating unit 120. At the differentiating step 220, a first derivative at each pixel position is obtained. At Step S101 in FIG. 5, a pixel position for obtaining the first derivative is expressed as (i, j). Subsequent to Step S101, the process proceeds to Step S102, and a value of a variable src is expressed as RAW data of the pixel position (i, j). Further, a variable diffx for outputting differential data in the x-direction at the pixel position (i, j) and a variable diffy for outputting differential data in the y-direction at the pixel position (i, j) are secured.

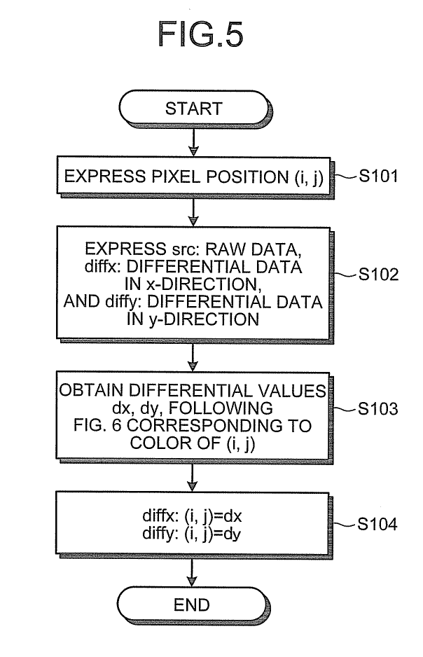

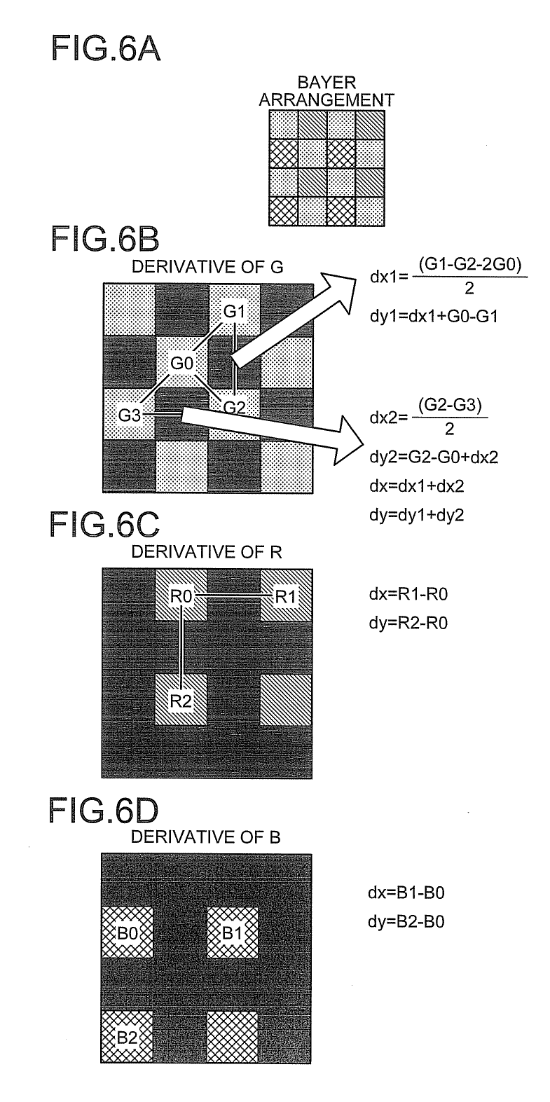

Subsequent to Step S102, the process proceeds to Step S103, and differential values dx and dy are obtained by a method shown in FIGS. 6A to 6D corresponding to a color component at the pixel position (i, j). In FIGS. 6A to 6D, first derivatives are independently obtained for RGB. The RAW data needs to be processed because arrangements of RGB are different.

FIG. 6A depicts the Bayer arrangement. FIGS. 6C and 6D depict examples for obtaining first derivatives of R and B. R and B are square lattice arrangements in coarser sampling than that of G. In FIGS. 6C and 6D, the first derivatives in the x-direction and the first derivatives in the y-direction are approximate in differences in each direction. When the first derivative in the x-direction and the first derivative in the y-direction are expressed as dxᵢ and dyᵢ, respectively, dxᵢ and dyᵢ can be calculated by the following equation (1) when ci==R or c_{i ==B.}

dxᵢ=y_{i+(2, 0)}_{^{T}}−yᵢ

dyᵢ=y_{i+(0, 2)}_{^{T}}−yᵢ (1)

On the other hand, G shown in FIG. 6B is a diagonal lattice in the Bayer arrangement, and thus a process different from that of R and B is performed. Focusing on a fact that a first element of Taylor expansion is a first derivative, the first derivative is obtained by fitting a plane, of which the Taylor expansion is discontinued by first differentiation, using G at two points. Considering two triangles shown in FIG. 6B, a sum of first derivatives of these triangles is obtained by fitting a plane to these triangles.

First, the following equation (2) is established for a first triangle. By solving the equation (2), a first derivative of the first triangle is obtained. An equation (3) expresses the first derivative of the first triangle.

$$\begin{matrix}{y}_{i + {( 1 , - 1 )}^{T}} = {y}_{i} + d x 1 - d y 1 \\ {y}_{i + {( 1 , 1 )}^{T}} = {y}_{i} + d x 1 + d y 1 & ( 2 ) \\ d x 1 = \frac{{y}_{i + {( 1 , - 1 )}^{T}} + {y}_{i + {( 1 , 1 )}^{T}} - 2 {y}_{i}}{2} \\ d y 1 = d x 1 + {y}_{i} - {y}_{i + {( 1 , - 1 )}^{T}} & ( 3 )\end{matrix}$$

For a second triangle, an equation (4) is similarly established. By solving the equation (4), a first derivative of the second triangle is obtained. An equation (5) expresses the first derivative of the second triangle.

$$\begin{matrix}{y}_{i + {( - 1 , 1 )}^{T}} = {y}_{i} - d x 2 + d y 2 \\ {y}_{i + {( 1 , 1 )}^{T}} = {y}_{i} + d x 2 + d y 2 & ( 4 ) \\ d x 2 = \frac{{y}_{i + {( 1 , 1 )}^{T}} - {y}_{i + {( - 1 , 1 )}^{T}}}{2} \\ d y 2 = {y}_{i + {( 1 , 1 )}^{T}} - {y}_{i} + d x 2 & ( 5 )\end{matrix}$$

Further, by obtaining a sum of the equation (3) and the equation (5) by the next equation (6), a first derivative of G is obtained.

dxᵢ=dx1+dx2

dyᵢ=dy1+dy2 (6)

Referring back to FIG. 5, at Step S104 subsequent to Step S103, values of variables diffx and diffy become dx and dy, respectively, and the process is finished.

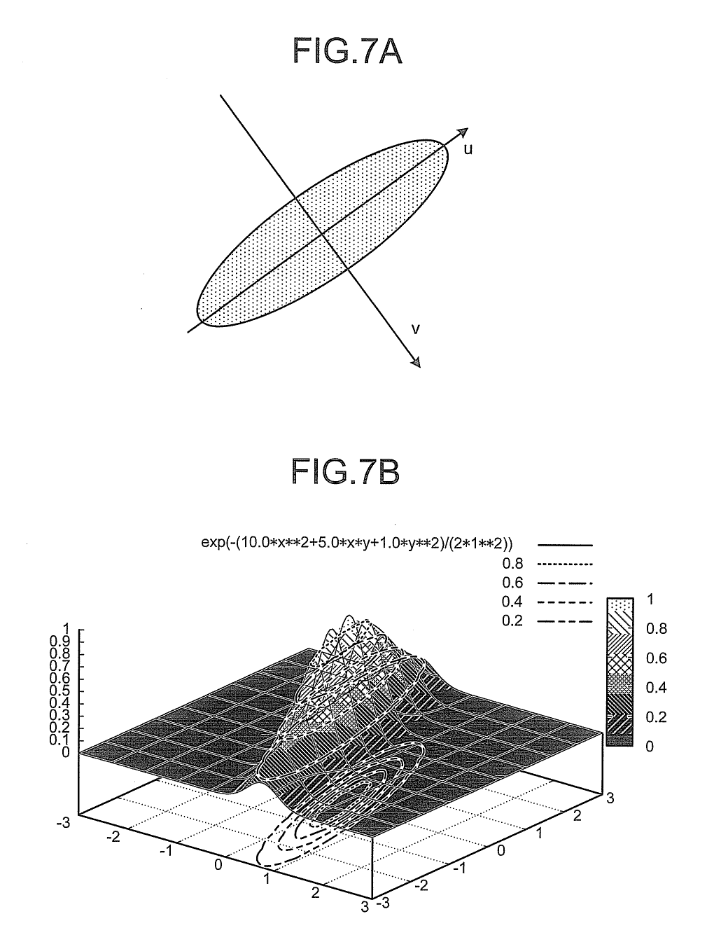

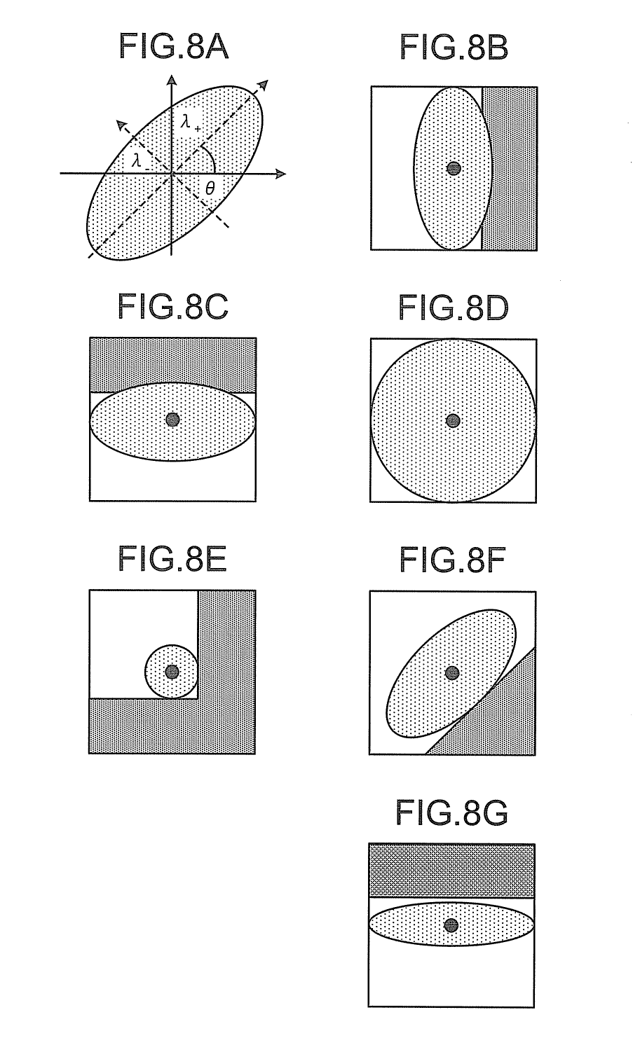

FIGS. 7A and 7B and FIGS. 8A to 8G are schematic diagrams for explaining an anisotropic Gaussian function used at the image-structure-parameter calculating step 230. As a statistic amount expressing a local structure of an image, there is a structure tensor, for example. Cumani et al. calculated detailed strength directions of edges by using an eigenvalue and an eigenvector of a structure tensor (A. Koschan, M. Abidi, “Detection and classification of edges in color images”, Signal Processing Magazine, IEEE, Volume 22, Issue 1, January 2005, Pages: 64-73).

Further, the weight of fitting can be determined from a structure tensor. An anisotropic Gaussian function having a structure tensor as a covariance matrix is used. FIGS. 7A and 7B depict an anisotropic Gaussian function. FIG. 7A is a plan view of the anisotropic Gaussian function, and FIG. 7B is a birds-eye view of the anisotropic Gaussian function.

In FIG. 8A, λ₊ and λ₋ represent a large eigenvalue and a small eigenvalue, respectively, and θ represents an angle formed by the eigenvector and the x-axis. The eigenvector becomes a direction along an edge. The anisotropic Gaussian function having a structure tensor as a covariance matrix has an ellipse broken along a strong direction of edge strength. Therefore, sharpness is maintained by preventing fitting striding edges.

Image-structure kernel parameters expressing directions and sizes of edges at a position i are calculated here in a similar manner to that of Cumani et al. by using the first derivatives in the x-direction and the first derivatives in the y-direction obtained at the differentiating step 220. The image structure kernel is expressed by the anisotropic Gaussian function shown in FIG. 8A, and a structure tensor Hi of a differential value is defined by the following equation (7)

$$k ( i , s ) = exp ( - \frac{1}{{h}^{2}} {s}^{T} {H}_{i} s ) \\ {H}_{i} = [ \begin{matrix}d {x}_{i}^{2} & d {x}_{i} d {y}_{i} \\ d {x}_{i} d {y}_{i} & d {y}_{i}^{2}\end{matrix} ] \qquad ( 7 )$$

In the equation (7), s∈N represents a position of a point within a local vicinity N centered around the position i. Global smooth h>0 represents a standard deviation of the anisotropic Gaussian function. By the global smooth h, strength of smoothening can be set. That is, when a value of h is large, smoothening becomes strong. FIGS. 8B to 8G depict a relationship between an edge and an image structure kernel. These image structure kernels become elliptical shapes crashed in a tangent direction of an edge when a normal-line direction component of the edge is strong, that is, when the edge becomes clearer.

From the structure tensor Hᵢ of the equation (7), the image-structure kernel parameters can be calculated by the following equations (8) and (9).

$$\begin{matrix}{λ}_{\pm } = \frac{{C}_{xx} + {C}_{yy}}{2} \pm \sqrt{\frac{{( {C}_{xx} - {C}_{yy} )}^{2}}{4} + {C}_{xy}^{2}} \\ θ = \{ \begin{matrix}\frac{π}{4} & if ( {C}_{xx} = {C}_{yy} ) ⋂ ( {C}_{xy} > 0 ) \\ - \frac{π}{4} & if ( {C}_{xx} = {C}_{yy} ) ⋂ ( {C}_{xy} < 0 ) \\ 0 & if {C}_{xx} = {C}_{yy} = {C}_{xy} = 0 \\ \frac{1}{2} {tan}^{- 1} ( \frac{2 {C}_{xy}}{{C}_{xx} - {C}_{yy}} ) & otherwise\end{matrix} \\ where & ( 8 ) \\ Hi = [ \begin{matrix}d {x}_{i}^{2} & d {x}_{i} d {y}_{i} \\ d {x}_{i} d {y}_{i} & d {y}_{i}^{2}\end{matrix} ] = [ \begin{matrix}{C}_{xx} & {C}_{xy} \\ {C}_{xy} & {C}_{yy}\end{matrix} ] & ( 9 )\end{matrix}$$

In the equation (8), an image structure angle θ represents an angle formed by the x-axis of an image and a long axis direction of the image structure kernel, λ₊ represents a length of a long axis direction, and λ₋ represents a length of a short axis direction. Both λ₊ and λ₋ are eigenvalues of the structure tensor. A long axis of the image structure kernel is a tangent direction of an edge, and a short axis of the image structure kernel matches a normal line direction of the edge.

In the equations (8) and (9), image-structure kernel parameters are not stably calculated due to noise included in the image. Therefore, a structure tensor convolved regarding a point within the local vicinity N centered around the position i in the next equation (10) can be used.

$${H}_{i} = \frac{1}{Num ( N )} {\sum }_{s ∈ N} [ \begin{matrix}d {x}_{i + s}^{2} & d {x}_{i + s} d {y}_{i + s} \\ d {x}_{i + s} d {y}_{i + s} & d {y}_{i + s}^{2}\end{matrix} ] \qquad ( 10 )$$

In the equation (10), an optional shape can be considered for the local vicinity N. For example, a rectangular region of 5×5 taps centered around the position i can be used.

The deblurring algorithm of the Landweber method includes a blur reproducing step and a blur correcting step. The Landweber method is a method of repetitively updating a blur-corrected image to minimize a squared error of a blur reproduction image of blurring a blur-corrected image by using the PSF and the RAW data.

At the blur reproducing step 240, the PSF is applied to the blur-corrected image, thereby generating a blur reproduction image. At first, the RAW data inputted from the image sensor 110 is used as an initial data of the blur-corrected image. A blur reproduction image bᵢ is obtained by the following equation (11) by convolving the image of a local region N centered around the pixel position i, by weighting the pixel with the PSF.

$${b}_{i} = {\sum }_{s ∈ N} h ( - s ; i , {c}_{i} ) {x}_{i + s} \\ {b}_{i} \text{:} Blur reproduction image \\ i \text{:} Pixel position \\ N \text{:} Local region centered around i \qquad ( 11 )$$

In the equation (11), a local position within the local region N is expressed as s.

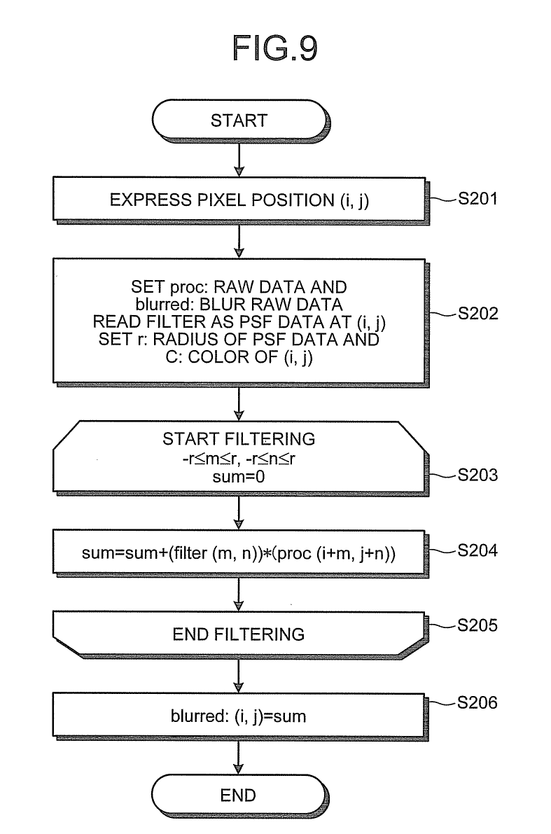

FIG. 9 is a flowchart for explaining details of the blur reproducing step 240 performed by the blur reproducing unit 141 and the like. At Step S201 in FIG. 9, a pixel position (i, j) at which the blur reproduction process is performed is determined. Subsequent to Step S201, the process proceeds to Step S202, and a predetermined value is substituted into each variable.

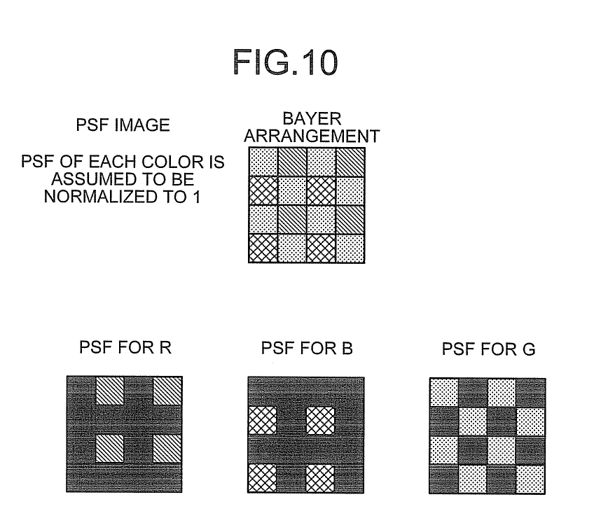

Specifically, a value of the RAW data at the pixel position (i, j) is set to an array variable proc, and a variable blurred is set as a variable into which a blur RAW data at the pixel position (i, j) is substituted. PSF data at the pixel position (i, j) is read, and is substituted into an array variable filter. In FIG. 10, the PSF of each color component corresponds to the Bayer arrangement, and is normalized.

Further, a radius r of the PSF data and a color component type of the pixel position (i, j) are set.

Subsequent to Step S202, the process proceeds to Step S203, and a filtering process is started. As an initial value, a value 0 is substituted into a variable sum, and filtering ranges m and n are set as −r≦m≦r and −r≦n≦r. Subsequent to Step S203, the process proceeds to Step S204, and a numerical value obtained by multiplying the value of the array variable filter to the value of the variable proc is added to a value of the variable sum. That is, the value of the variable sum is updated by an equation of sum=sum+(filter(m, n))*(proc(i+m, j+n)).

Subsequent to Step S204, the process proceeds to Step S205. When a process of using each variable of the array variable filter is all finished, the process proceeds to Step S206. When a process of using each variable of the array variable filter is not all finished, the process returns to Step S204, and the process is repeated.

At Step S206 subsequent to Step S205, the value of the variable sum is substituted into a variable blurred (i, j), and the process is finished.

At the blur correcting step 205, the blur-corrected image is updated to minimize a squared error of the blur reproduction image and the RAW data. A squared-error minimization problem becomes an equation (12). Update equations by the method of steepest descent of the equation (12) become an equation (13) and an equation (14).

$$\begin{matrix}{min}_{x} {\sum }_{i ∈ Ω} {E}_{i} = {( {y}_{i} - {b}_{i} )}^{2} \\ Ω \text{:} Aggregate of points of entire image & ( 12 ) \\ \begin{matrix}\frac{d {x}_{i}}{d t} = - α \frac{\partial {E}_{i}}{\partial {x}_{i}} \\ = α {\sum }_{s ∈ N} h ( s ; i , {c}_{i} ) ( {y}_{i} - {b}_{i}^{( l )} )\end{matrix} & ( 13 ) \\ {b}_{i}^{( 1 )} = {\sum }_{s ∈ N} h ( - s ; i , {c}_{i} ) {x}_{i + s} & ( 14 )\end{matrix}$$

When differential equations of the equation (13) and the equation (14) are substituted by difference equations, an update equation by the Landweber method is obtained as an equation (15).

$${x}_{i}^{( l + 1 )} = {x}_{i}^{( l )} + α {\sum }_{s ∈ N} h ( s ; i , {c}_{i} ) ( {y}_{i} - {b}_{i}^{( l )} ) \\ {b}_{i}^{( l )} = {\sum }_{s ∈ N} h ( - s ; i , {c}_{i} ) {x}_{i + s} \qquad ( 15 )$$

In the equation (15), a superscript suffix (1) is a numerical value expressing a number of times of iterations.

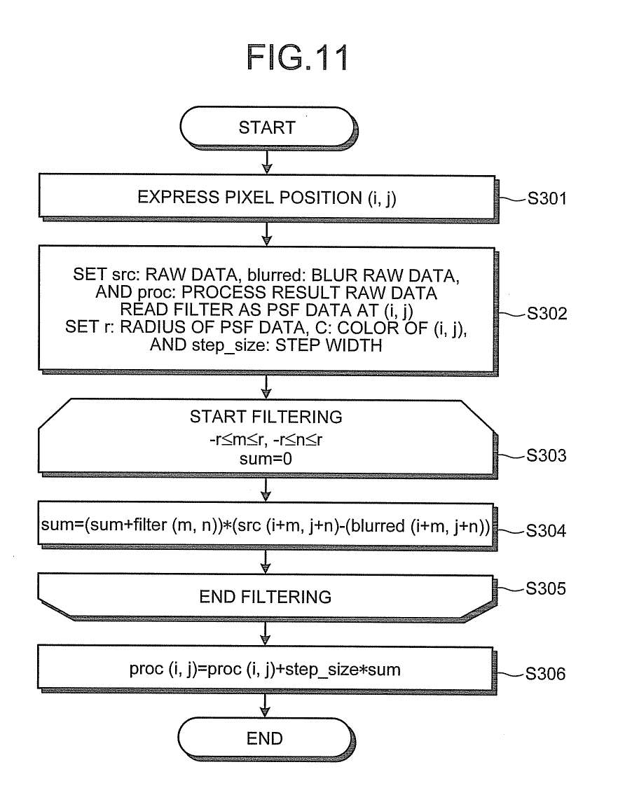

FIG. 11 is a flowchart for explaining details of the blur correcting step 250 performed by the blur correcting unit 151 and the like. At Step S301 in FIG. 11, the pixel position (i, j) at which a blur correction process is performed is determined. Subsequent to Step S301, the process proceeds to Step S302, and a predetermined value is substituted into each variable.

Specifically, the RAW data centered around the pixel position (i, j) is substituted into an array variable src, and the blur RAW data at the pixel position (i, j) obtained at the blur reproducing step 240 is substituted into an array variable blurred.

Further, the array variable proc is set as a variable into which a value of the RAW data after correction at the pixel position (i, j) is substituted, and the PSF data at the pixel position (i, j) is read and is substituted into the array variable filter.

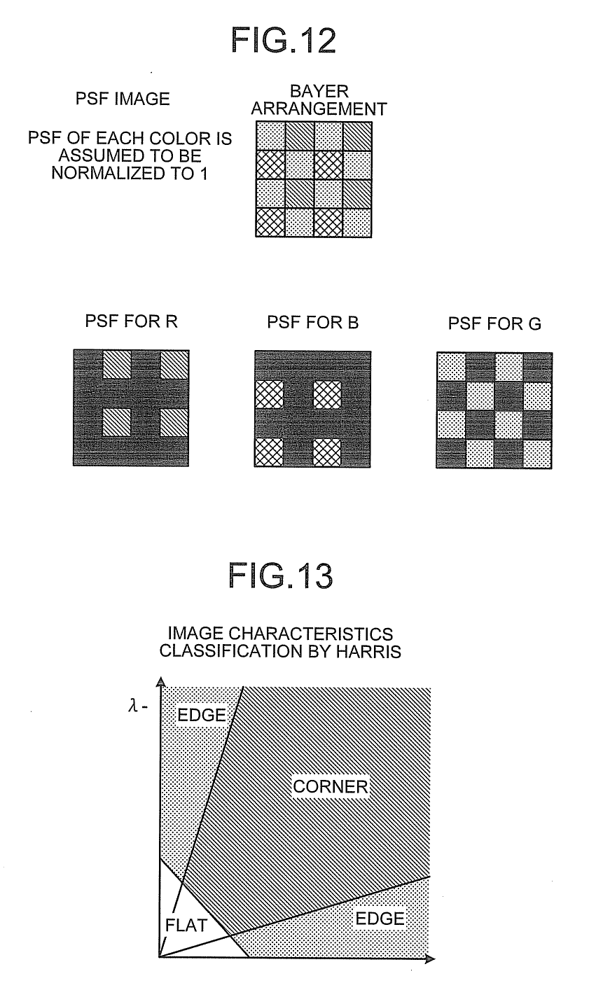

In FIG. 12, the PSF for each color component corresponds to the Bayer arrangement, and is normalized. Referring back to FIG. 11, at Step S302, a radius r of the PSF data, a color component type C at the pixel position (i, j), and a step width step size are set.

Subsequent to Step S302, the process proceeds to Step S303, and a filtering process is started. As an initial value, the value 0 is substituted into the variable sum, and the filtering ranges m and n are set as −r≦m≦r and −r≦n≦r.

Subsequent to Step S303, the process proceeds to Step S304, and a numerical value obtained by subtracting a value of the array variable blurred from a number obtained by multiplying the value of the array variable filter to the value of the variable src is added to a value of the variable sum. That is, the value of the variable sum is updated by an equation of sum=sum+(filter(m, n))*(src(i+m, j+n))−(blurred(i+m, j+n)).

Subsequent to Step S304, the process proceeds to Step S305. When a process of using each variable of the array variable filter is all finished, the process proceeds to Step S306. When a process of using each variable of the array variable filter is not all finished, the process returns to Step S304, and the process is repeated.

At Step S306 subsequent to Step S305, the value of the variable proc is updated by an equation of proc(i, j)=proc(i, j)+step_size*sum, and the process is finished.

At the curved-surface fitting step 270, curved-surface fitting is performed to the blur-corrected image by using a curved-surface model interconnected to RGB shown in FIG. 3, thereby obtaining a noise-suppressed smooth blur-corrected image. A polynomial function shown in the following equation (16) is available as an example of a model achieving this interconnection. The polynomial function approximates distribution of pixel values of each of color components of the blur-corrected image.

f_{R}(s)=a_{R}+a₀s+a₁t+a₂s²+a₃st+a₄t²

f_{G}(s)=a_{G}+a₀s+a₁t+a₂s²+a₃st+a₄t²

f_{B}(s)=a_{B}+a₀s+a₁t+a₂s²+a₃st+a₄t² (16)

In the above equation, aᵢ=(a_{R}, a_{G}, a_{B}, a₀, a₁, a₂, a₃)^{T} is a parameter of a curved-surface model, and a constant term (a_{R}, a_{G}, a_{B})^{T} becomes a pixel value of the blur-corrected image after the fitting. The local position s is sometimes set in parallel with reference coordinates (x, y)^{T} of an image, and in this case, the local position s does not reflect a local structure. On the other hand, the local structure of the image can be expressed by an eigenvalue and a rotation angle of a structure tensor calculated at the image-structure-parameter calculating step. Therefore, curved-surface fitting that matches the image structure can be performed by setting a curved-surface model that reflects the image structures.

The local position s of the pixel position i is coordinate-converted to local coordinates uv of the image structure kernel corresponding to the rotation angle θ. A coordinate conversion from an st coordinate of an image to a local coordinate uv of the rotation kernel is shown in the following equation (17).

$$u = {R}^{- 1} ( θ ) s \\ {R}^{- 1} ( θ ) = [ \begin{matrix}cos θ & sin θ \\ - sin θ & cos θ\end{matrix} ] \qquad ( 17 )$$

In the above equation, u=(u, v)^{T} is a local coordinate of the image structure kernel, u represents a long-axis direction of an ellipse, and v represents a short-axis direction of the ellipse.

At the image-structure-parameter calculating step in the first embodiment, parameters of a tangent direction of an edge, a long axis and a short axis of an ellipse representing local characteristics of the image are calculated by using a structure tensor. Harris et al. classify characteristics of an image from the structure tensor (C. Harris and M. Stephens (1988), “A Combined Corner and Edge Detector”, Proc. of the 4th ALVEY Vision Conference: pp. 147-151).

FIG. 13 is a schematic diagram for explaining an image characteristic classification by Harris et al., where λ₊ and λ₋ represent eigenvalues of the structure tensor. In FIG. 13, image characteristics are classified into an edge region, a flat region, and a corner region. When one eigenvalue is large and also when the other eigenvalue is small, an ellipse is broken, and this expresses an edge region. When both eigenvalues are large, an ellipse becomes a small isotropic circle, and this expresses a corner region such as an angle and a sharp edge. When both eigenvalues are small, an ellipse becomes a large isotropic circle, and this expresses a flat region.

In the edge region, information is concentrated in the edge normal direction, that is, on the v-axis, and therefore, a model of the next equation (18) can be applied to the edge region.

f_{R}(u)=a_{R}+a₁v+a₂v²+a₃v³+a₄v⁴

f_{G}(u)=a_{G}+a₁v+a₂v²+a₃v³+a₄v⁴

f_{B}(u)=a_{B}+a₁v+a₂v²+a₃v³+a₄v⁴ (18)

On the other hand, in the corner region and the flat region, information is not concentrated on the v-axis as the short axis, because these regions are isotropic ellipses. Therefore, both the u-axis and the v-axis can be suitably used for these regions. Because the corner region includes a large change of pixels, a curved-surface model having a high degree of freedom is suitable for the corner region. Therefore, a model of the next equation (19) can be applied to the corner region.

f_{R}(u)=a_{R}+a₁u+a₂u²+a₃u³+a₄u⁴+a₅v+a₆v²+a₇v³+a₈v⁴

f_{G}(u)=a_{G}+a₁u+a₂u²+a₃u³+a₄u⁴+a₅v+a₆v²+a₇v³+a₈v⁴

f_{B}(u)=a_{B}+a₁u+a₂u²+a₃u³+a₄u⁴+a₅v+a₆v²+a₇v³+a₈v⁴ (19)

Because noise is desired to be minimized in the flat region, a low-order curved-surface model is used for the flat region. A model of the next equation (20) can be applied to the flat region.

f_{R}(u)=a_{R}+a₁u+a₂u²+a₃v+a₄v²

f_{G}(u)=a_{G}+a₁u+a₂u²+a₃v+a₄v²

f_{B}(u)=a_{B}+a₁u+a₂u²+a₃v+a₄v² (20)

At a curved-surface model selection step, an image concerned is classified following the classification shown in FIG. 13, based on the eigenvalues λ₊ and λ₋ of the structure tensor, and the curved-surface model is selected corresponding to this classification. The next equation ( 21 ) is a vector notation of the curved-surface model.

$$f ( u ) = [ \begin{matrix}{f}_{R} ( u ) \\ {f}_{G} ( u ) \\ {f}_{B} ( u )\end{matrix} ] = [ \begin{matrix}1 & 0 & 0 & u & {u}^{2} & v & {v}^{2} \\ 0 & 1 & 0 & u & {u}^{2} & v & {v}^{2} \\ 0 & 0 & 1 & u & {u}^{2} & v & {v}^{2}\end{matrix} ] [ \begin{matrix}{a}_{R} \\ {a}_{G} \\ {a}_{B} \\ {a}_{1} \\ {a}_{2} \\ {a}_{3} \\ {a}_{4}\end{matrix} ] = p ( u ) {a}_{i} \qquad ( 21 )$$

In the curved-surface fitting step, an unknown curved-surface parameter aᵢ is obtained in a state that noise is included in the observed RAW data. This can be solved by the least squares method. Least square problems are shown in the next equations (22) and (23).

$$\begin{matrix}{\hat{a}}_{i} = {min}_{a} E ( i , a ) & ( 22 ) \\ \begin{matrix}E ( i , a ) = {\sum }_{s ∈ N} k ( i , s ) {‖ {x}_{i + s}^{( l + 1 )} - {c}_{i + s}^{T} f ( {R}^{- 1} ( θ ) s ) ‖}^{2} \\ = {\sum }_{s ∈ N} k ( i , s ) {‖ {x}_{i + s}^{( l + 1 )} - {c}_{i + s}^{T} p ( {R}^{- 1} ( θ ) s ) a ‖}^{2}\end{matrix} & ( 23 )\end{matrix}$$

In the above equations, a circumflex (aᵢ) represents a least-square fitting parameter, and k(i, s) represents a weight at the point s. The equation (7) of the rotation kernel is used here. A color filter vector cᵢ is defined by the next equation (24).

$${c}_{i} = \{ \begin{matrix}{( 1 , 0 , 0 )}^{T} & if {c}_{i} = R \\ {( 0 , 1 , 0 )}^{T} & if {c}_{i} = G \\ {( 0 , 0 , 1 )}^{T} & if {c}_{i} = B\end{matrix} \qquad ( 24 )$$

The color filter vector is used to connect between the RAW data and an RGB curved-surface model. While an optional shape can be considered for the local vicinity N, a rectangular region of 5×5 taps centered around the position x can be used, for example.

The difference of the PSF for each color can be reflected as a weight. The PSF is different for each color component of RGB, and there is a case, depending on a lens, that while G is not blurred, R and B are blurred, for example.

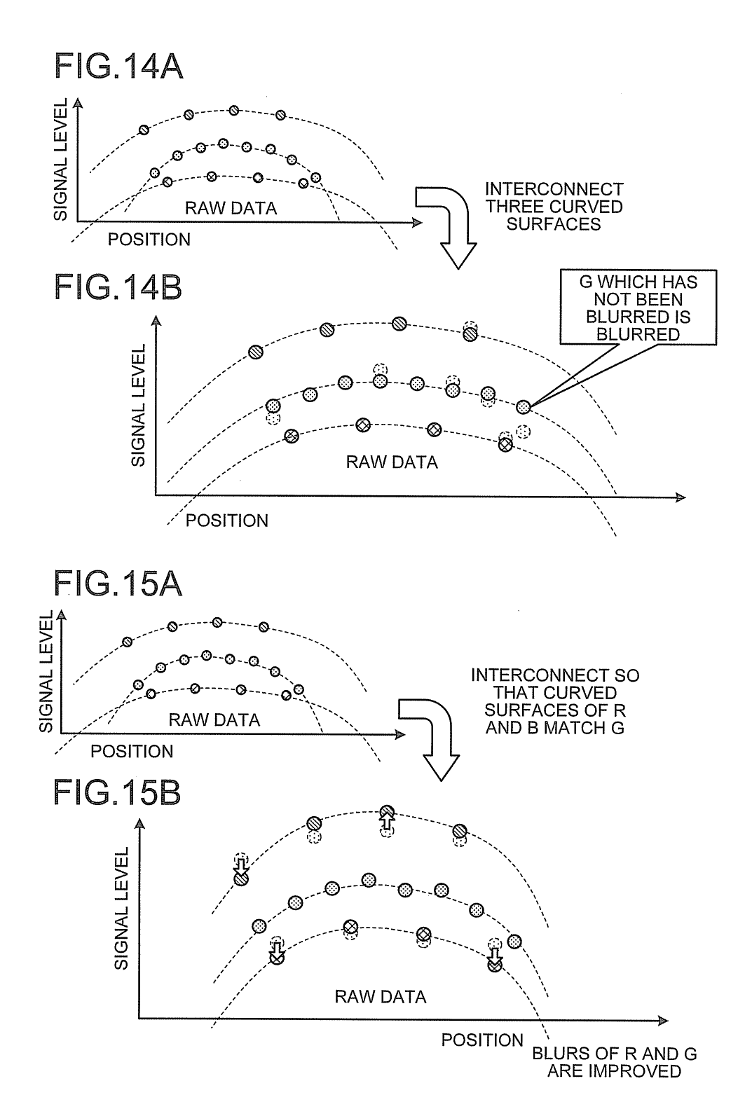

FIGS. 14A and 14B and FIGS. 15A and 15B are schematic diagrams illustrating curved surfaces of RGB before and after curved-surface shapes are interconnected by the RGB. FIGS. 14A, 14B are schematic diagrams illustrating a process of interconnecting between curved-surface shapes without considering the difference of the PSF between the RGB, where FIG. 14A depicts a curved-surface shape before performing curved-surface fitting, and FIG. 14B depicts a curved-surface shape after performing curved-surface fitting. When the difference of the PSF is not considered, curved surfaces are fitted to R, G, and B to average-curvature curved surfaces, and G is blurred.

On the other hand, FIGS. 15A and 15B are schematic diagrams illustrating a process of interconnecting between curved-surface shapes by considering the difference of the PSF between RGB. As shown in FIG. 15B, when the fitting is performed in a curved-surface shape along a curvature of G by considering the difference of the PSF between RGB, the blurs of R and B can be removed without blurring G. The next equation (25) is an error function at the time of performing curved-surface fitting by considering the difference of the PSF.

$$E ( i , a ) = {\sum }_{s ∈ N} {r}_{{C}_{i}} k ( i , s ) {‖ {x}_{i + s}^{( l + 1 )} - {c}_{i + s}^{T} p ( {R}^{- 1} ( θ ) s ) a ‖}^{2} \qquad ( 25 )$$

In the above equation, r_{ci}≦0 is a correction coefficient according to the PSF for each color component. A weight is increased for a color component having less blur, and weights are decreased for other color components. To simplify the description, the equation (25) is changed to equations (26) and (27) in a matrix form.

$$\begin{matrix}E ( i , a ) = {( Y - P a )}^{T} W ( Y - P a ) & ( 26 ) \\ Y = [ \begin{matrix}{x}_{i + {s}_{0}}^{( l + 1 )} \\ ⋮ \\ {x}_{i + {s}_{n}}^{( l + 1 )}\end{matrix} ] \\ W = [ \begin{matrix}k ( i , {s}_{0} ) & 0 & 0 \\ 0 & ⋱ & 0 \\ 0 & 0 & k ( i , {s}_{n} )\end{matrix} ] \\ P = [ \begin{matrix}{c}_{i + {s}_{0}}^{T} p ( {R}^{- 1} ( θ ) {s}_{0} ) \\ ⋮ \\ {c}_{i + {s}_{n}}^{T} p ( {R}^{- 1} ( θ ) {s}_{n} )\end{matrix} ] & ( 27 )\end{matrix}$$

A point within the local vicinity is N={s₀, . . . , s_{N}}. When a matrix form is used, a solution of the least squares method is uniquely obtained from the next equation (28).

âᵢ=(P^{T} WP)⁻¹ P^{Y} WY (28)

The equation (28) is called a normal equation, and this becomes an optimum solution in the case of a linear least squares method. Numerical values of an inverse matrix can be calculated by an LU decomposition or a singular value decomposition. The value (a_{R}, a_{G}, a_{B})^{T} within the circumflex (aᵢ) is a pixel value after the fitting. A blur-corrected image is updated by a curved-surface-fitted pixel value as shown in the next equation (29).

$${x}_{i}^{( l + 2 )} = {c}_{i}^{T} [ \begin{matrix}{a}_{R} \\ {a}_{G} \\ {a}_{B}\end{matrix} ] \qquad ( 29 )$$

When the value (a_{R}, a_{G}, a_{B})^{T} is output as it is, the whole values of RGB can be obtained, and demosaicing can be also performed.

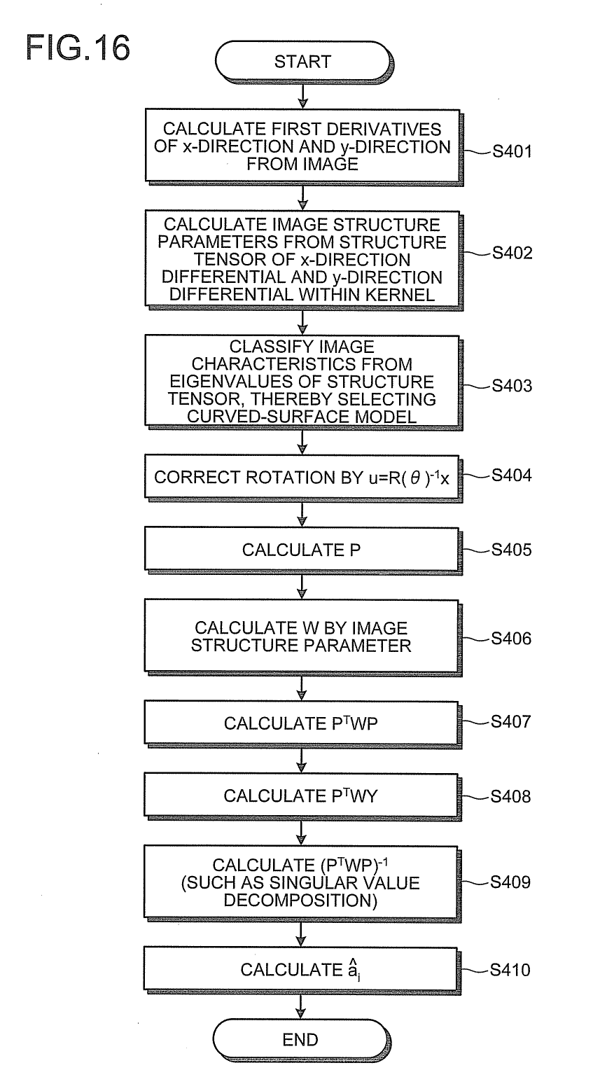

FIG. 16 is a flowchart of details and the like of the curved-surface fitting step 270. The process in FIG. 16 is mainly performed by the curved-surface fitting unit 170.

At Step S401, the differentiating unit 120 calculates first derivatives in the x-direction and the y-direction from the RAW data of the image. Subsequent to Step S401, the process proceeds to Step S402. The image-structure parameter calculator 130 calculates the image structure parameters from the structure tensor of the x-direction differential and y-direction differential within the kernel.

Subsequent to Step S402, processes at Step S403 to Step S410 are performed by the curved-surface fitting step 270. At Step S403, image characteristics are classed following FIG. 13 and the like, from the eigenvalues of the structure tensor, thereby selecting a curved-surface model.

Subsequent to Step S403, the process proceeds to Step S404, and a rotation correction is performed by the equation (17). Subsequent to Step S404, the process proceeds to Step S405, and P is calculated by the equation (27). Subsequent to Step S405, the process proceeds to Step S406, and W is calculated by the equation (27) by using the image structure parameters.

Subsequent to Step S406, P^{T}WP and P^{T}WY are calculated at Step S407 and Step S408, respectively. Subsequent to Step S408, the process proceeds to Step S409, and (P^{T}WP)⁻¹ is calculated. Subsequent to Step S409, the process proceeds to Step S410, and the circumflex (aᵢ) is calculated.

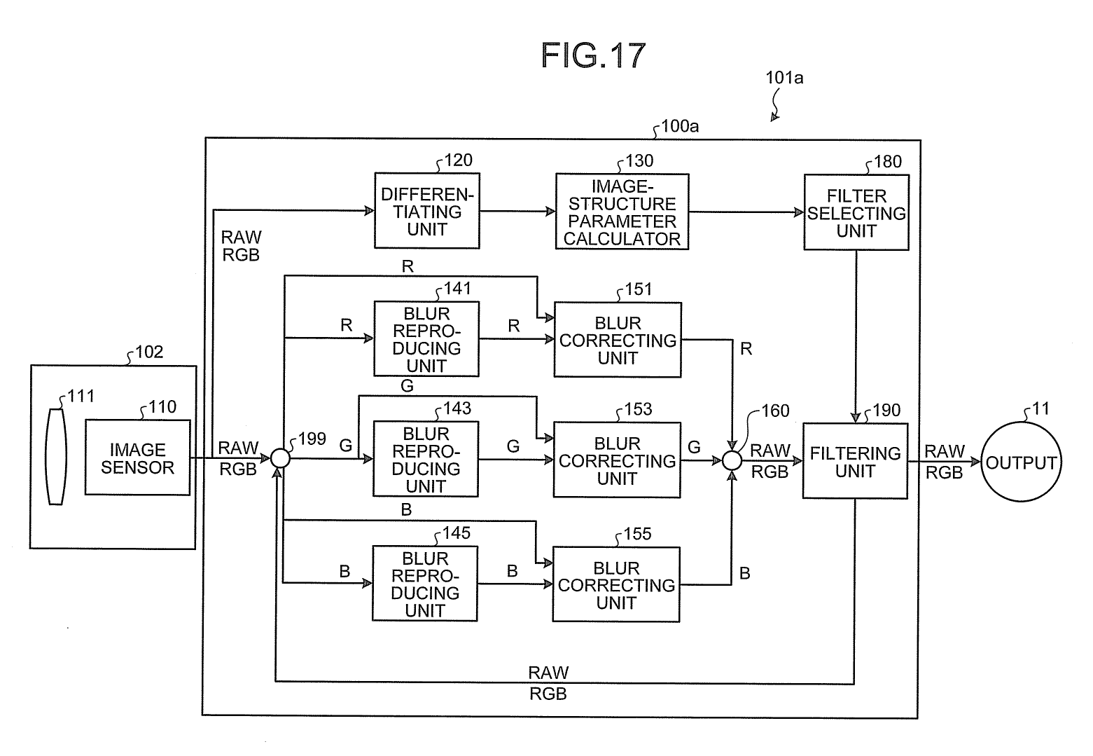

FIG. 17 is a block diagram illustrating a functional configuration of an imaging device according to a second embodiment of the present invention. The imaging device 101a includes an imaging unit 102 and an image processing apparatus 100a in FIG. 17.

An image processing apparatus 100a in FIG. 17 includes the image sensor 110, the differentiating unit 120, the image-structure parameter calculator 130, the blur reproducing unit 141, the blur reproducing unit 143, the blur reproducing unit 145, the blur correcting unit 151, the blur correcting unit 153, the blur correcting unit 155, the multiplexer 160, a filter selecting unit 180, a filtering unit 190, and the demultiplexer 199.

In FIG. 17, blocks having the same functions and the same configurations as those of the imaging device 101 in FIG. 1 are assigned with like reference numerals, and explanations thereof will be omitted here.

The filter selecting unit 180 selects a filter from a lookup table (hereinafter, “LUT”) storing filter coefficients as a result of solving a normal equation stored in a storage unit or the like (not shown). As a result, a configuration facilitating installation by a circuit is provided. The filtering unit 190 performs a filter process by a filter selected by the filter selecting unit 180.

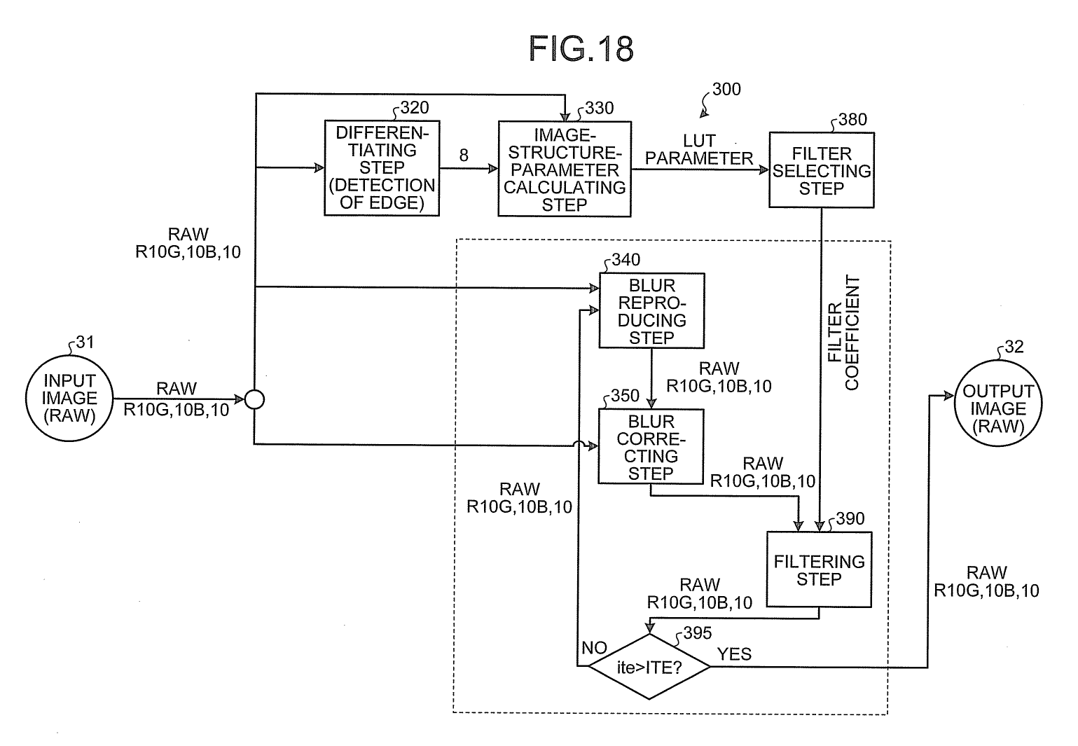

FIG. 18 is a schematic diagram for explaining an image processing method employed by the image processing apparatus 100 a according to the second embodiment. In the second embodiment, curved-surface fitting is performed by the kernel regression for regularization, by using the deblurring algorithm according to the Landweber method in a similar manner to that in the first embodiment.

The deblurring algorithm according to the Landweber method includes a blur reproducing step 340, and a blur correcting step 350. The Landweber method is independently performed for each color component of RGB.

The curved-surface fitting by the kernel regression includes a differentiating step 320, an image-structure-parameter calculating step 330, a filter selection step 380, a filtering step 390, and a determination step 395.

The filter selection step 380 and the filtering step 390 that are different from the steps of the image processing method in FIG. 2 are explained below, and explanations of other steps will be omitted.

At the filter selection step 380, a normal equation is solved in advance, and as a result, one filter is selected from filters stored in the LUT. Accordingly, a configuration that facilitates installation by a circuit is established. At the filtering step 390, a filtering process is performed by the filter selected at the filter selection step 380.

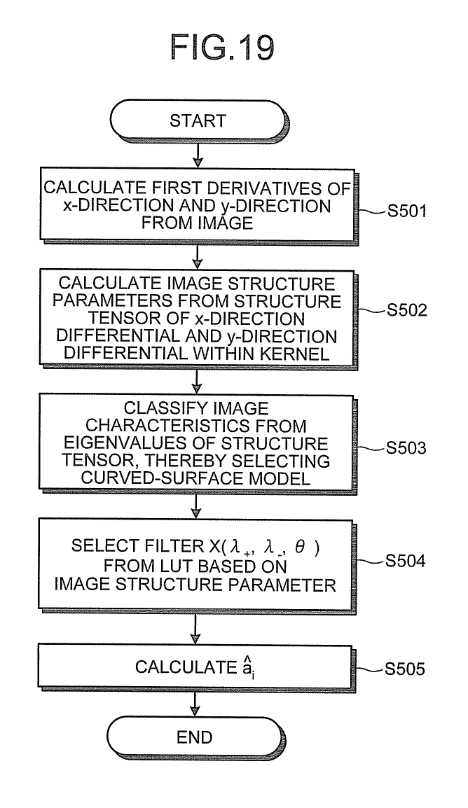

At Step S501 in FIG. 19, the differentiating unit 120 calculates first derivatives in the x-direction and the y-direction from the RAW data of the image. Subsequent to Step S501, the process proceeds to Step S502. The image-structure parameter calculator 130 calculates the image structure parameters from the structure tensor of the x-direction differential and y-direction differential within the kernel.

Subsequent to Step S502, the process proceeds to Step S503. The filter selecting unit 180 classes the image characteristics, subsequent to FIG. 13, for example, from the eigenvalues of the structure tensor obtained at Step S502, thereby selecting a curved-surface model. Subsequent to Step S503, the process proceeds to Step S504. The filter selecting unit 180 selects a filter X(λ₊, λ₋, θ)ₘ by the image structure parameter obtained at Step S502.

Subsequent to Step S504, the process proceeds to Step S505, and the filtering unit 190 calculates the circumflex (aᵢ).

At the filter selection step 380, a proper filter is selected from the LUT as a result of solving the normal equation, based on the image structure parameter calculated at the image-structure-parameter calculating step 330.

The normal equation is given by the equation (28). Based on the equation (27), Y expresses a pixel value and changes depending on the input image. On the other hand, (P^{T}WP)⁻¹ (P^{T}W) is a portion that depends on only a pixel structure parameter (λ₊, λ₋, θ) and does not depend on the image. The image structure kernel becomes the next equation (30), from the structure tensor of differentiation of the input image expressed in the equation (7).

$$k ( i , s ) = exp ( - \frac{1}{{h}^{2}} {s}^{T} {H}_{i} s ) \\ {H}_{i} = [ \begin{matrix}d {x}_{i}^{2} & d {x}_{i} d {y}_{i} \\ d {x}_{i} d {y}_{i} & d {y}_{i}^{2}\end{matrix} ] \qquad ( 30 )$$

The equation (30) is rewritten as an equation (31) based in the image structure parameter. The rotation kernel becomes as expressed in an equation (32).

$$\begin{matrix}\begin{matrix}{H}_{i} = [ \begin{matrix}{λ}_{+} {cos}^{2} θ + {λ}_{-} {sin}^{2} θ & ( {λ}_{+} - {λ}_{-} ) sin θcos θ \\ ( {λ}_{+} - {λ}_{-} ) sin θcos θ & {λ}_{+} {sin}^{2} θ + {λ}_{-} {cos}^{2} θ\end{matrix} ] \\ = H ( {λ}_{+} , {λ}_{-} , θ )\end{matrix} & ( 31 ) \\ k ( {λ}_{+} , {λ}_{-} , θ , s ) = exp ( - \frac{1}{{h}^{2}} {s}^{T} H ( {λ}_{+} , {λ}_{-} , θ ) s ) & ( 32 )\end{matrix}$$

A matrix W becomes an equation (33), and depends on only the image structure parameter. Similarly, a matrix P becomes an equation (34), and depends on only the image structure parameter.

$$\begin{matrix}\begin{matrix}W ( {λ}_{+} , {λ}_{-} , θ ) = [ \begin{matrix}k ( i , {s}_{0} ) & 0 & 0 \\ 0 & ⋱ & 0 \\ 0 & 0 & k ( i , {s}_{n} )\end{matrix} ] \\ = [ \begin{matrix}k ( {λ}_{+} , {λ}_{-} , θ , {s}_{0} ) & 0 & 0 \\ 0 & ⋱ & 0 \\ 0 & 0 & k ( {λ}_{+} , {λ}_{-} , θ , {s}_{n} )\end{matrix} ]\end{matrix} & ( 33 ) \\ P ( θ ) = [ \begin{matrix}{c}_{i + {s}_{0}}^{T} p ( {R}^{- 1} ( θ ) {s}_{0} ) \\ ⋮ \\ {c}_{i + {s}_{n}}^{T} p ( {R}^{- 1} ( θ ) {s}_{n} )\end{matrix} ] & ( 34 )\end{matrix}$$

Therefore, an equation (35) also depends on only the image structure parameter.

X(λ₊, λ₋, θ)=(P(θ)^{T} W(λ₊, λ₋, θ)P(θ))⁻¹ P(θ))^{T} W(λ₊, λ₋, θ) (35)

When X(λ₊, λ₋, θ)ₘ and (m=0, . . . , M) are calculated in advance for arbitrarily discretized sets of image structure parameters (λ₊, λ₋, θ)₁ and (m=0, . . . , M), a solution can be obtained by the next equation (36) without performing an additional calculation.

âᵢ=X(λ₊, λ₋, θ)ₘ Y (36)

At the filter selection step 380, X(λ₊, λ₋, θ)ₘ and (m=0, . . . , M) are calculated in advance for the sets of image structure parameters (λ₊, λ₋, θ), and (m=0, . . . , M), and the calculated result is registered into the LUT. The LUT is also called “filter bank”. More specifically, a process of selecting corresponding X(λ₊, λ₋, θ)ₘ from the LUT is performed based on the calculated image structure parameter (λ₊, λ₋, θ).

At the filtering step 390, a computation of convolution with the pixel value vector Y is performed to calculate a least-square-fitted output pixel, by using the filter X(λ₊, λ₋, θ)ₘ selected at the filter selection step 380. Specifically, a matrix calculation shown in the next equation (37) is performed.

$${\hat{a}}_{i} = {X ( {λ}_{+} , {λ}_{-} , θ )}_{m} Y = {X ( {λ}_{+} , {λ}_{-} , θ )}_{m} [ \begin{matrix}{x}_{i + {s}_{0}} \\ ⋮ \\ {x}_{i + {s}_{n}}\end{matrix} ] \qquad ( 37 )$$

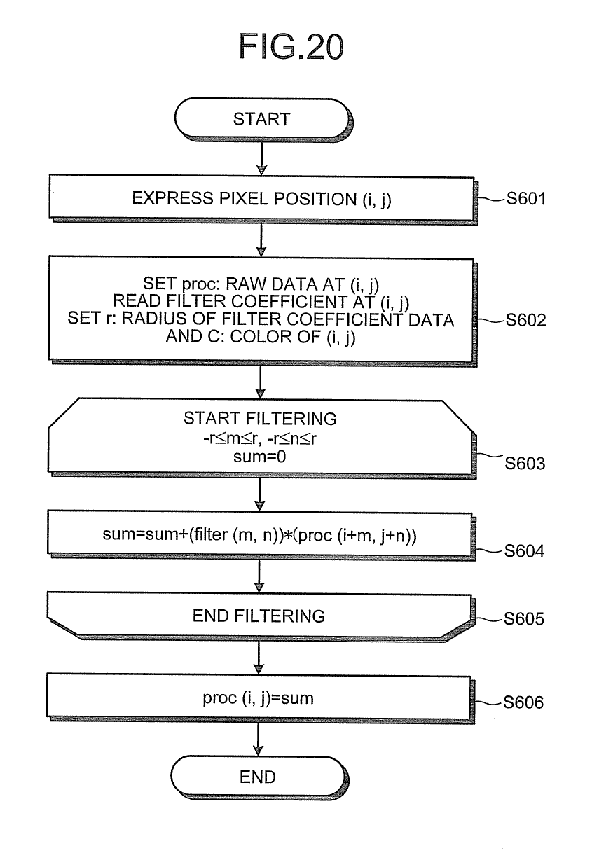

FIG. 20 is a flowchart for explaining details of the filtering step 390. Step S601 to Step S606 in FIG. 20 are substantially the same as Step S201 to S206, except that filter coefficients calculated in advance and stored in the LUT are used.

At Step S601 in FIG. 20, the pixel position (i, j) at which a blur reproduction process is performed is determined. Subsequent to Step S601, the process proceeds to Step S602, and a predetermined value is substituted into each variable.

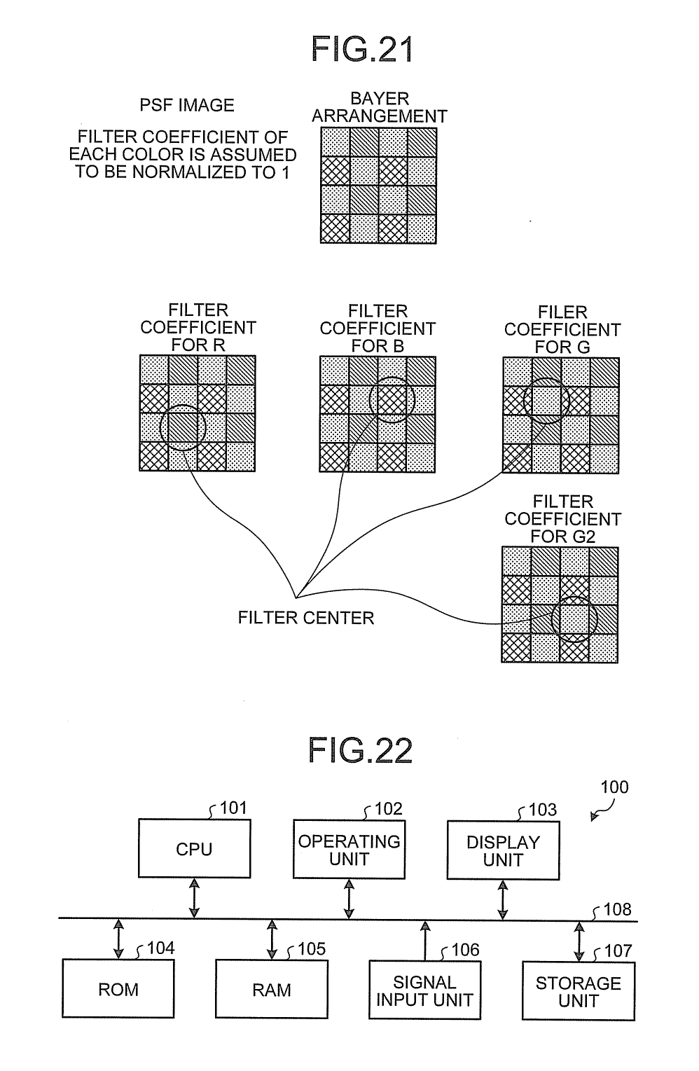

Specifically, the RAW data at the pixel position (i, j) is set to the array variable proc. A filter coefficient at the pixel position (i, j) is read, and is substituted into the array variable filter. In FIG. 21, the PSF for each color component corresponds to the Bayer arrangement, and is normalized. FIG. 21 further depicts a filter center for each color component in the Bayer arrangement. The filter center is any one of center four pixels in the Bayer arrangement of 4×4. Returning to FIG. 20, a color component type C at the pixel position (i, j) is set.

Subsequent to Step S602, the process proceeds to Step S603, and a filtering process is started. As an initial value, the value 0 is substituted into the variable sum, and the filtering ranges m and n are set as −r≦m≦r and −r≦n≦r. Subsequent to Step S603, the process proceeds to Step S604, and a numerical value obtained by multiplying the value of the array variable filter to the value of the variable proc is added to a value of the variable sum. That is, the value of the variable sum is updated by an equation of sum=sum+(filter(m, n))*(proc(i+m, j+n)).

Subsequent to Step S604, the process proceeds to Step S605. When a process of using each variable of the array variable filter is all finished, the process proceeds to Step S606. When a process of using each variable of the array variable filter is not all finished, the process returns to Step S604, and the process is repeated.

At Step S606 subsequent to Step S605, the value of the variable sum is substituted into a predetermined array position of the array variable proc. The predetermined array position is obtained by an equation of proc−r*h_size−r. The process is finished after Step S606.

FIG. 22 is a block diagram illustrating a hardware configuration of a computer 400 that realizes the image processing apparatus according to the second embodiment. As shown in FIG. 22, the computer 400 includes a central processing unit (CPU) 401, an operating unit 402, a display unit 403, a read only memory (ROM) 404, a random access memory (RAM) 405, a signal input unit 406, and a storage unit 407. These units are connected to each other by a bus 408.

The CPU 401 performs various kinds of process in cooperation with various programs stored in advance in the ROM 404 and the like, by using a predetermined region of the RAM 405 as an operation region. The CPU 401 integrally controls the operation of each unit constituting the computer 400. The CPU 401 further performs the image processing method according to the second embodiment, in cooperation with programs stored in advance in the ROM 404 and the like. A computer program to cause the computer to perform the image processing method according to the second embodiment can be stored in an information recording medium that is inserted into a drive for the computer to read the program.

The operating unit 402 includes various kinds of input keys, receives information input by a user as an input signal, and outputs the received input signal to the CPU 401.

The display unit 403 includes a display such as a liquid crystal display (LCD), and displays various kinds of information based on a display signal from the CPU 401. The display unit 403 can be configured as a touch panel integrally with the operating unit 402.

The ROM 404 unrewritably stores programs and various kinds of setting information concerning the control of the computer 400. The RAM 405 is a storage unit such as a synchronous dynamic RAM (SDRAM), functions as an operation area of the CPU 401, and works as a buffer and the like.

The signal input unit 406 converts a moving image and voice into electric signals, and outputs the electric signal to the CPU 401 as an image signal. The signal input unit 406 can be a broadcast-program receiving device (a tuner) or the like.

The storage unit 407 includes a magnetically or optically recordable recording medium, and stores data such as an image signal obtained via the signal input unit 406 or an image signal input from outside via a communication unit or an interface (I/F) (not shown).

While exemplary embodiments for carrying out the present invention have been explained above, the present invention is not limited to the above embodiments. Various modifications can be made without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a blur reproducing unit that generates blur-reproduced image data by reproducing a predetermined blur of a lens, with respect to blur-corrected image data of which an initial data is input image data inputted from an image sensor;
a blur correcting unit that corrects the blur-corrected image data so that an error between the blur-reproduced image data and the input image data becomes smaller; and
a curved-surface fitting unit that obtains curve surface parameters of each functions approximating distribution of pixel values of each of color components of the blur-corrected image data so that curved-surface shapes of the functions become the same among the color components, and updates the pixel values of the blur-corrected image data by using the curve surface parameters.

2. The apparatus according to claim 2, wherein the curved-surface fitting unit calculates the curve surface parameters by a least squares method.

3. The apparatus according to claim 4, wherein the curved-surface fitting unit calculates the curve surface parameters by weighting a pixel value in a region of the blur-corrected image data corresponding to a local region for each of the color components.

4. The apparatus according to claim 2, comprising an image-structure parameter calculator that calculates image-structure parameters based on pixels of the input image data, image-structure parameters indicating image characteristics of the input image data.

5. The apparatus according to claim 4, wherein the curved-surface fitting unit selects the functions based on the image-structure parameters and calculates the curve surface parameters by weighting the pixel value in the region of the blur-corrected image data, based on a strength of an edge held by the local region and a direction of the edge.

6. The apparatus according to claim 2, wherein the curved-surface fitting unit calculates the curve surface parameters by using the functions sharing one or more curve surface parameters among the color components.

7. The apparatus according to claim 3, wherein the curved-surface fitting unit obtains a filter value from a table holding the filter value and updates the pixel values of the blur-corrected image data by multiplying the filter value to a pixel value of each color component of the blur-corrected image data, the filter value being obtained by calculating a subexpression excluding a value of each color component of the blur-corrected image data in a matrix of the least squares method making the curved-surface shapes the same among the color components.

8. The apparatus according to claim 7, comprising a storage unit that stores the filter value in advance.

9. The apparatus according to claim 7, wherein the curved-surface fitting unit obtains the filter value based on a strength of an edge and a direction of the edge.

10. An imaging device comprising:
a lens that collects an external beam;
an image sensor that accepts the the external beam via the lens and outputs image data as input image data;
a blur reproducing unit that generates blur-reproduced image data by reproducing a predetermined blur of the lens, with respect to blur-corrected image data of which an initial data is the input image data;
a blur correcting unit that corrects the blur-corrected image data so that an error between the blur-reproduced image data and the input image data becomes smaller; and
a curved-surface fitting unit that obtains curve surface parameters of each functions approximating distribution of pixel values of each of color components of the blur-corrected image data so that curved-surface shapes of the functions become the same among the color components, and updates the pixel values of the blur-corrected image data by using the curve surface parameters.

11. An image processing method comprising:
generating blur-reproduced image data by reproducing a predetermined blur of a lens, with respect to blur-corrected image data of which an initial data is input image data inputted from an image sensor;
correcting the blur-corrected image data so that an error between the blur-reproduced image data and the input image data becomes smaller; and
obtaining curve surface parameters of each functions approximating distribution of pixel values of each of color components of the blur-corrected image data so that curved-surface shapes of the functions become the same among the color components; and
updating the pixel values of the blur-corrected image data by using the curve surface parameters.

12. A computer program product having a computer readable medium including programmed instructions for processing an image, wherein the instructions, when executed by a computer, cause the computer to perform:
generating blur-reproduced image data by reproducing a predetermined blur of a lens, with respect to blur-corrected image data of which an initial data is input image data inputted from an image sensor;
correcting the blur-corrected image data so that an error between the blur-reproduced image data and the input image data becomes smaller; and
obtaining curve surface parameters of each functions approximating distribution of pixel values of each of color components of the blur-corrected image data so that curved-surface shapes of the functions become the same among the color components; and
updating the pixel values of the blur-corrected image data by using the curve surface parameters.
